(19) United States
(12) Patent Application Publication
(10) Pub. No.: US 2015/0342206 A1
(43) Pub. Date: Dec. 3, 2015

(54) FLAVOR ACCELERATOR SYSTEM

(71) Applicants: David Berger, Oakland, CA (US); Sandra Berger, Oakland, CA (US)

(72) Inventors: David Berger, Oakland, CA (US); Sandra Berger, Oakland, CA (US)

(21) Appl. No.: 14/291,263

(22) Filed: May 30, 2014

(51) Int. Cl. A23B 4/12; A23B 7/10

(52) U.S. Cl. CPC A23B 4/12; A23B 7/10

(57) ABSTRACT

A flavor accelerator system to speed imparting flavor into a foodstuff within a container comprising a hollow needle, where the hollow need extends between a tip and an end; a hose attached to the end of the hollow needle, where the hose is attached to a carbon dioxide canister at an opposite end from the hollow needle; and an injection lid on the container, where the injection lid seals the container, and where the injection lid includes an inlet port within the injection lid; and an injection nipple at a top of the injection port, where the injection nipple receives the hollow needle; wherein the hollow needle injects carbon dioxide into the container through the inlet port within the injection lid to accelerate the speed at which the foodstuff is flavored.

### BACKGROUND OF THE INVENTION

1. Field of the Invention

The present invention relates to a device that accelerates the amount of time necessary to impart a marinate or flavor solution into a foodstuff.

2. Description of Related Art

Pickling and marinating are great ways to infuse flavor into food products like fruits, vegetables, and meats. Pickling is typically used to preserve foods through fermentation, where the food is exposed to an acidic brine or vinegar for an extended period of time. The resulting food tastes bitter or salty with notes of any spices or herbs that are in the brine before fermentation. Marination is a similar process through which usually a meat is soaked in a liquid to absorb the distinct flavors of the marinade. With marinades, acidic liquids like vinegar, lemon juice or even wine are used to break down the muscle fibers of the meat and impart the flavor. Other acidic ingredients may be used like fruits such as pineapple or oranges for a sweeter flavoring on the meat.

While these methods of flavoring are useful they are often messy, and require considerable amounts of time to reach the desired taste. For marinades, the time required is typically hours or even days for the food to absorb the flavor. On the other hand, pickling can take weeks, months and even years before the entire fermentation process is complete. Because of the time requirements, these cooking processes are very cumbersome and tedious to accomplish. Therefore it would be beneficial in the art to provide a way to marinade a food that considerably reduces the amount of time required to impart the flavor.

### SUMMARY OF THE INVENTION

In view of the foregoing disadvantages inherent in the prior art, the general purpose of the present invention is to provide a flavor accelerator system to speed imparting flavor into a foodstuff within a container, configured to include all of the advantages of the prior art, and to overcome the drawbacks inherent therein.

Accordingly, an object of the present invention is to provide a flavor accelerator system that injects carbon dioxide into a pickling container thereby drastically reducing the amount of time required to pickle the food.

To achieve the above objects, in an aspect of the present invention, a flavor accelerator system is described comprising a hollow needle, where the hollow need extends between a tip and an end; a hose attached to the end of the hollow needle, where the hose is attached to a carbon dioxide canister at an opposite end from the hollow needle; and an injection lid on the container, where the injection lid seals the container, and where the injection lid includes an inlet port within the injection lid; and an injection nipple at a top of the injection port, where the injection nipple receives the hollow needle; wherein the hollow needle injects carbon dioxide into the container through the inlet port within the injection lid to accelerate the speed at which the foodstuff is flavored.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawing, wherein like elements are identified with like symbols, and in which:

FIG. 1 depicts an enlarged perspective view of a flavor accelerator system in accordance with an exemplary embodiment of the present invention; and

FIG. 2 depicts a perspective view of a flavor accelerator system in accordance with an exemplary embodiment of the present invention.

FIG. 3 depicts an injection lid used in accordance with the present invention.

Like reference numerals refer to like parts throughout the description of several views of the drawings.

### DETAILED DESCRIPTION OF THE DRAWINGS

The present invention relates to a device that accelerates the amount of time necessary to impart a marinade or flavor solution into a foodstuff. The present invention provides a flavor accelerator system to facilitate the process of pickling and marinating. The flavor accelerator system includes an elongated need connected to a hose. The hose is connected to a pressurized carbon dioxide canister. The needle is inserted into a specialized lid that includes an injection port. Once inserted, the carbon dioxide is injected into the container to speed up the marinating process. The carbon dioxide increases the rate of osmosis for the vinegars or brine to enter the fruits, vegetables or meats that are being flavored. Thus, the flavor accelerator system allows users to pickle vegetables and marinade meats in a mess-free, rapid and efficient manner.

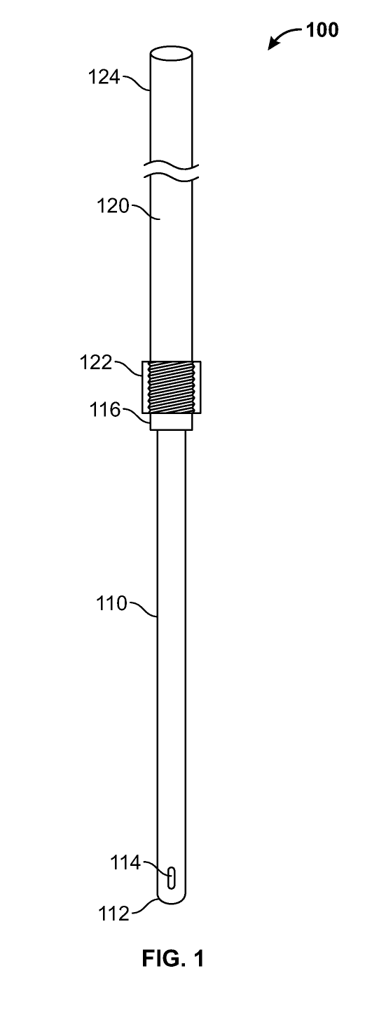

Turning now descriptively to the drawings, referring to FIG. 1, a perspective view of a flavor accelerator system 100 is shown in accordance with an exemplary embodiment of the present invention. The flavor accelerator system 100 includes an elongated hollow needle 110 and an injection lid 130. The needle 110 couples with a hose 120 which is in turn connected to a carbon dioxide canister. The needle 110 extends from a tip 112 to an attachment end 116. The tip 112 includes a gas outlet port 114 to release carbon dioxide from the canister. The attachment end 116 is threaded to attach to an adapter 122 at an end of the hose 120. At a second end of the hose 120 the carbon dioxide canister 150 is attached. The needle 110 is large gauge, and stainless steel to withstand repeated insertion and substantial pressure change, so that it will not collapse or break with multiples uses.

As shown in FIG. 3, the injection lid 130 attaches to a container that houses foodstuff like meat, vegetables or fruits and a pickling or marinating liquid. The injection lid 130 includes an airtight cover 132 that securely fastens to the container. The cover 132 may be plastic, aluminum or the like to tightly screw or snap onto the container. Within a central portion of the injection lid 130 is an inlet port 134. The inlet port 134 includes a shoulder 126 to seal the inlet port 134 against the cover 132. At a top portion of the inlet port 134 is an injection nipple 138. The injection nipple 138 receives the needle 110 as an inlet for the needle 110 to inject the carbon dioxide into the container. Below the injection plug 138 is a valve 140 to ensure that the inlet port 134 remains airtight even when the needle 110 is inserted within the injection lid 130. The inlet port 134 is made from rubber so that an airtight seal is maintained with or without the needle 110.

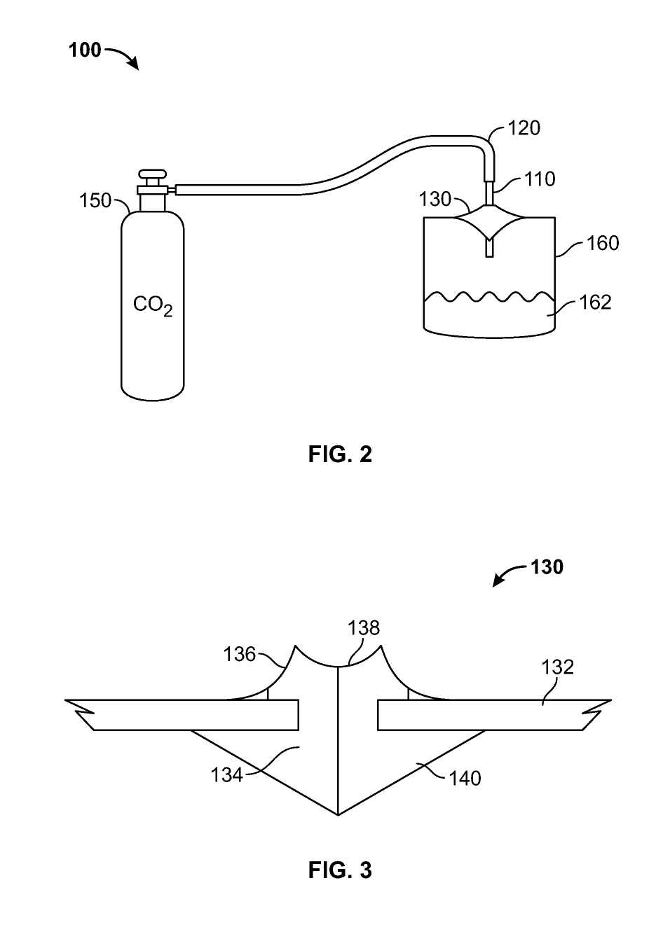

Referring now to FIG. 2, a perspective view of the flavor accelerator system 100 is shown. The hose 120 reaches between the container 160 with the marinating or pickling foodstuff 162 and the carbon dioxide canister 150. The needle 110 is tightly inserted into the injection lid 130 to transfer the carbon dioxide from the canister 150 into the container 160. Once the carbon dioxide is within the container 160 the rate at which the foodstuff marinates or pickles is greatly increased allowing flavor impart to occur much more rapidly than simply resting within the container.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A flavor accelerator system to speed imparting flavor into a foodstuff within a container comprising:
a. a hollow needle, where the hollow need extends between a tip and an end;
b. a hose attached to the end of the hollow needle, where the hose is attached to a carbon dioxide canister at an opposite end from the hollow needle; and
c. an injection lid on the container, where the injection lid seals the container, and where the injection lid includes:
i. an inlet port within the injection lid; and
ii. an injection nipple at a top of the injection port, where the injection nipple receives the hollow needle;
wherein the hollow needle injects carbon dioxide into the container through the inlet port within the injection lid to accelerate the speed at which the foodstuff is flavored.

2. The flavor accelerator system according to claim 1, where the inlet port includes a valve at a bottom portion, where the valve maintains an airtight seal on the injection lid.

3. The flavor accelerator system according to claim 1, where the end of the needle is threaded to fasten to an adapter at the end of the hose.

4. The flavor accelerator system according to claim 1, where the inlet port is made from rubber to ensure an airtight seal on the container.

5. The flavor accelerator system according to claim 1, where the needle includes a gas outlet port.
